(19) United States
(12) Patent Application Publication
(10) Pub. No.: US 2011/0145520 A1
(43) Pub. Date: Jun. 16, 2011

(54) AUDIO SIGNAL PROCESSING APPARATUS AND METHOD, AND COMMUNICATION TERMINAL APPARATUS

(75) Inventors: In-Ki HWANG, Daejeon-si (KR); Do-Young KIM, Daejeon-si (KR); Hyun-Joo BAE, Daejeon-si (KR); Byung-Sun LEE, Daejeon-si (KR)

(73) Assignee: Electronics and Telecommunications Research Institute, Daejeon-si (KR)

(21) Appl. No.: 12/951,658

(22) Filed: Nov. 22, 2010

(30) Foreign Application Priority Data
Dec. 16, 2009 (KR) 10-2009-0125612
May 11, 2010 (KR) 10-2010-0044030

(51) Int. Cl. G06F 12/00

(52) U.S. Cl. 711/154; 711/E12.001

(57) ABSTRACT

A signal processing technology achieved in a signal processing module, which is physically separate from a control module for controlling overall operations of a signal processing apparatus, is provided. Input of new data to a system memory is recognized. Upon the recognition of the input of the new data, the new data is read from the system memory. The new data read from the system memory is written to a local memory. Data sharing between software and hardware is effectively achieved in a system for performing a wideband codec processing using a dedicated hardware.

### CROSS-REFERENCE TO RELATED APPLICATION

This application claims the benefit under 35 U.S.C. §119(a) of Korean Patent Application No. 10-2009-0125612, filed on Dec. 16, 2009, and No. 10-2010-0044030, filed on May 11, 2010, the disclosures of which are incorporated by reference in its entirety for all purposes.

### BACKGROUND

1. Field

The following description relates to signal processing technology, and more particularly, to signal processing technology achieved in a signal processing module that is provided as a physically separate unit from a control module for controlling an overall operation of an apparatus.

2. Description of the Related Art

In general, the network bandwidth of an internet phone is narrow. As the use of the internet phone is increased, the demand for improved speech quality is becoming common. In order to satisfy such a demand for improved speech quality, a wideband speech/audio codec has been proposed. However, the wideband codec is designed to process larger amount of data in a broader bandwidth, the application of the wideband codec to the internet phone increase the computation for data processing as compared with a general internet phone using narrowband networks.

General internet phones using narrowband networks perform signal processing by use of a core processor without an additional processing apparatus for speech processing. However, the general internet phone has difficulty performing significant amount of signal processing that is increased under wideband communication.

In processing such a large amount of data, dedicated hardware may be used. Along the way parallel processing and pipelining having beneficial effect in a hardware manner are performed with hardware, and other operations, such as conditional processing, are performed with software.

### SUMMARY

In one aspect, there is provided a signal processing apparatus and a method thereof, capable of effectively sharing data between software and hardware when a dedicated hardware is introduced due to a large amount of data in wideband communication.

In one general aspect, there is provided an audio signal processing method achieved in a signal processing module which is physically separate from a control module for controlling overall operations of an apparatus. The method is as follows. Input of new data to a system memory is recognized. The new data is read from the system memory, upon the recognition of the input of the new data. The new data read from the system memory is written to a local memory.

In another general aspect, there is provided an audio signal processing apparatus. The apparatus includes a monitoring unit configured to monitor whether new data is input to a system memory, a local memory which is a storage space physically separate from the system memory and configured to store data, and a local memory control unit configured to read the new data from the system memory if the input of the new data is recognized in the monitoring unit, store the new data read from the system memory in the local memory and transfer a processing result of the data stored in the local memory to the system memory.

The signal processing apparatus and method according to the present invention offer effectiveness in sharing data between software and hardware in a system for performing wideband codec processing by use of dedicated hardware logic, thereby reducing the time required for processing data in wideband codec.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating an example of a communication terminal apparatus.

FIGS. 2 and 3 are flowcharts illustrating an example of an audio signal processing method.

FIG. 4 is timing diagrams illustrating a data write of a processor and a data read of an audio signal processing apparatus.

FIG. 5 is a timing diagram illustrating a case where shared data processed by the audio signal processing apparatus is moved to the system bus.

Elements, features, and structures are denoted by the same reference numerals throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

In general, a high specification processor (CPU) is required to apply a wideband codec of a communication terminal apparatus to an embedded system. Accordingly, it is preferred in terms of operational effectiveness that an operation having a computational complexity, such as conditional processing, is performed in software and other operations processable by parallel processing, such as simple computation, are performed in hardware.

If one function needs to be divided into portions to be processed by software and hardware, respectively, data needing to be shared between the software and hardware is shared through a system memory. In general, the input/output of the data is processed by use of a direct memory access controller (DMAC) in consideration of system efficiency. However, the audio signal processing apparatus and method according to the present invention perform the data input/output without using DMAC.

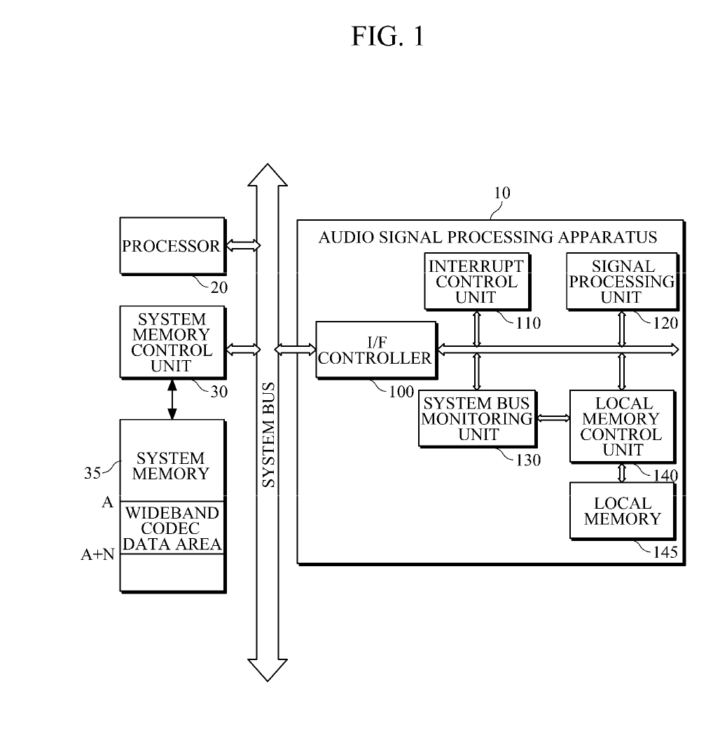

FIG. 1 is a block diagram illustrating an example of a communication terminal apparatus.

A communication terminal apparatus includes an audio signal processing apparatus 10. As shown in FIG. 1, the audio signal processing apparatus 10 includes an I/F controller 100, an interrupt control unit 110, and a signal processing unit 120 and a system bus monitoring unit 130.

In addition, the communication terminal apparatus may further include a system memory 35, a system memory control unit 30 configured to control read/write of data from/to the system memory 35 and a processor 20 configured to control an overall operation of a system. The system including the audio signal processing apparatus 10 may be an internet phone using wideband communication.

In general, externally input speech or audio signals are converted to digital signals and stored in the system memory 35 according to the control of the processor. The storing of data is achieved based on first in/first out (FIFO).

The system bus monitoring unit 130 monitors whether new data is input to the system memory 35. As an example, the system bus monitoring unit 130 monitors data of a region corresponding to addresses of a system bus. If data has been written to addresses included in a preset wideband codec data region, it is recognized that new data is input in the system memory 35.

The signal processing unit 120 is regarded as having a technological configuration of performing digital signal processing such as that of a general purpose digital signal processor (DSP). For example, the signal processing unit 120 may be configured to perform processes of accelerating audio signal processing. The audio signal processing apparatus 10 may further include a signal processing unit configured to perform preset signal processing on the data stored in the local memory and store a processing result value in the local memory.

A local memory 145 is a data storage space. According to an example, the local memory 145 is physically separate from the system memory 35.

As a result of monitoring in the system bus monitoring unit 130, if it is recognized that new data is input in the system memory 35, a local memory control unit 140 reads the new data input in the system memory 35 and stores the read new data in the local memory 145. The local memory control unit 140 transfers a result value of signal processing stored in the local memory 145 to the system memory 35. According to the present invention, only when the signal processing result value is different from a value stored in a corresponding region of the local memory 145, does the local memory control unit 140 transfer the signal processing result to the system memory 35.

The I/F controller 100 controls an interface with respect to the system bus. The interrupt control unit 110 generates an interrupt in accordance with a preset program.

The system memory control unit 30 generates address signals corresponding to specified memory addresses (A to A+N) to move data from the system memory 35 to the processor 20. The system memory control unit 30 stores a processing result of the processor 20 in the specified memory address of the system memory 35. As one example, in the initialization of the communication terminal apparatus, the system memory control unit 30 copies the data stored in the system memory 35 to the local memory 145.

In a conventional system, a program register value of the audio signal processing apparatus is activated, and then data shared with a processor is copied to a local memory included in an audio accelerating apparatus, from a system memory. In this case, the copying of data is achieved according to the control of a DMAC. After that, a signal processing module processes signals in a hardware manner. The resultant data of the signal processing is stored in the local memory. After the signal processing is completed, a local memory value is moved to a system memory according to a control of a DMAC. If an interrupt control module or a DMAC generates an interrupt, the processor recognizes that the operation of the audio accelerating apparatus is completed.

According to the present invention, the audio signal processing apparatus performs the control operation of the DMAC itself, thereby reducing the time required for data processing.

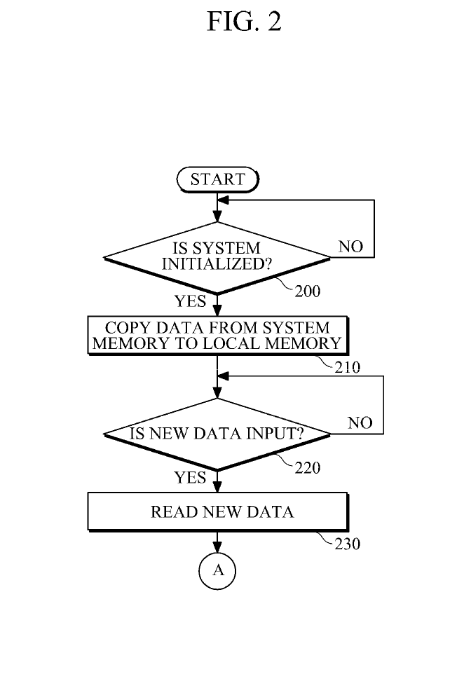

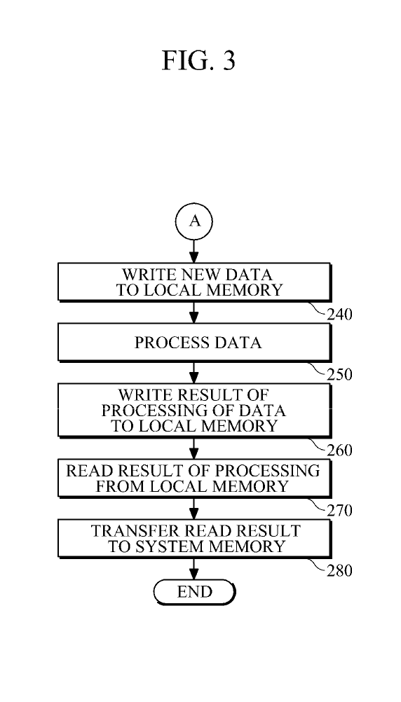

FIGS. 2 and 3 are flowcharts illustrating an example of an audio signal processing method.

As shown in FIGS. 2 and 3, a system starts operating and an initialization is performed (200). The initialization is achieved by setting a channel of the DMAC is directed from the system memory to the local memory of the audio accelerating apparatus such that an initial value of shared data is copied to the local memory of the audio signal processing apparatus (210).

It is monitored whether new data is stored in the system memory. If new data is input in the system memory (220), the new input data is read (230). The monitoring of input of new data is achieved by monitoring an address region of the system bus. If data is written to addresses included in a preset wideband codec data region, it is recognized that new data is input in the system memory.

The new input data read from the system memory is written to the local memory (240). Required data processing is performed on the data newly input to the local memory (250). The data processing may be identical to data processing performed in a general DSP. The result of the data processing is written to the local memory (260). Later, the result of the data processing is read from the local memory (270) and transferred to the system memory (280).

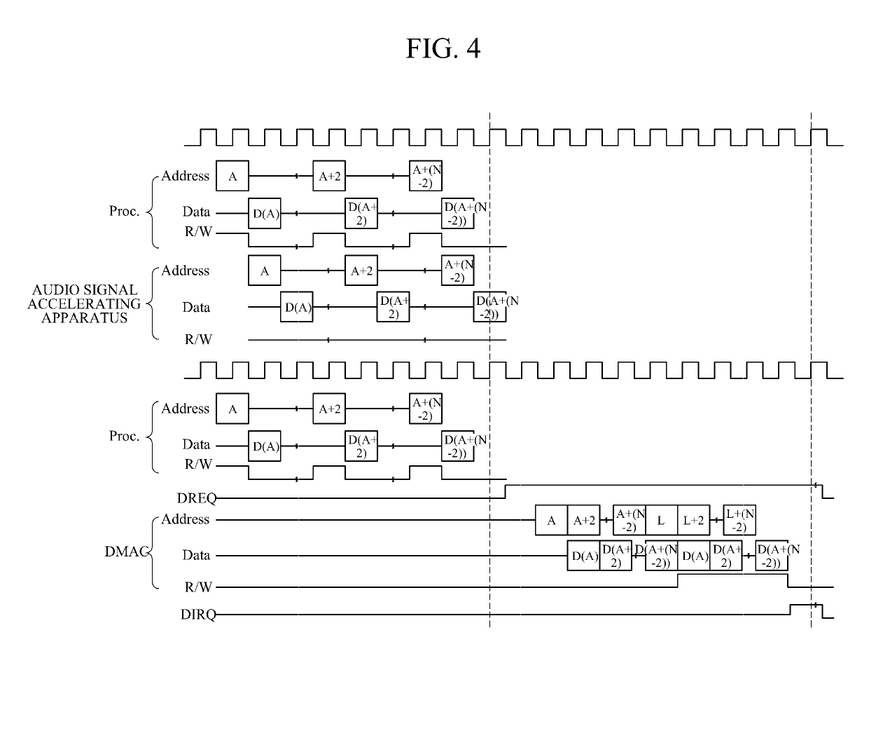

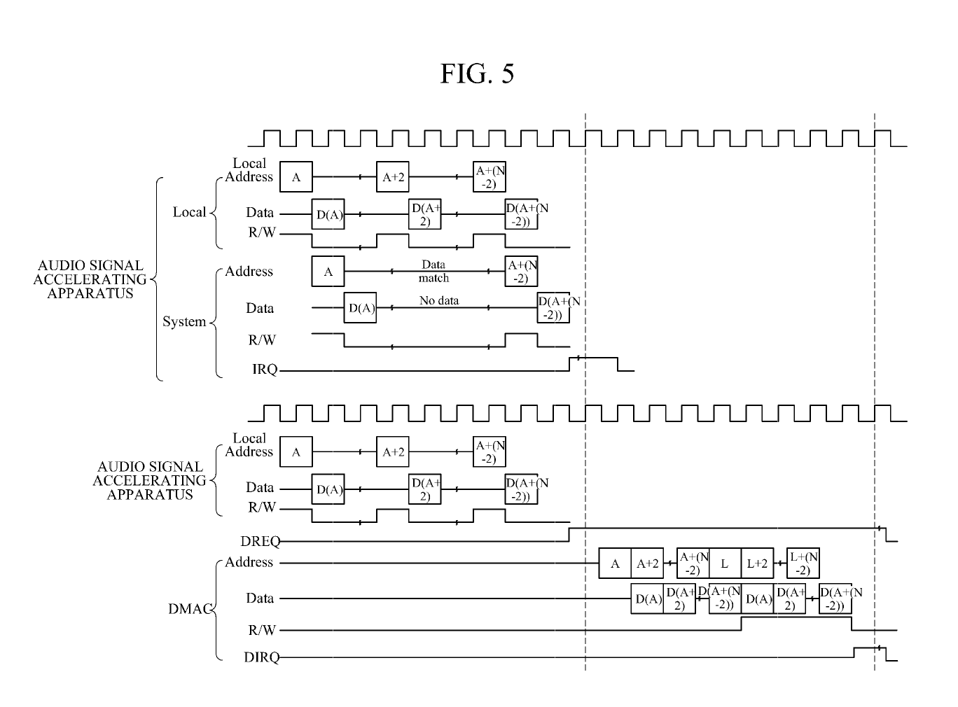

FIGS. 4 and 5 are timing diagrams illustrating the reduction in data processing time according to an example of an audio signal processing method.

FIG. 4 is timing diagrams illustrating a data write of a processor and a data read of an audio signal processing apparatus.

In general, if data input in a storage space exceeds a predetermined amount, an interrupt or a direct memory access request signal is generated. After that, the data is moved to a specified region of a system memory under the control of a processor or a DMAC module.

Since the amount of data for codec processing is preset to 1 frame or 2 frames, the processor or the DMAC module may determine the amount of transfer of data according to the preset amount of data. After a predetermined amount of data is stored in the system memory, the processor performs signal processing on the corresponding data. Since the signal processing takes a predetermined time, when the predetermined time has elapsed after one data is output, next data is output.

The lower part of FIG. 4 is a timing diagram illustrating a case where data is moved to the audio accelerating apparatus by use of a DMAC module in a conventional system. If new values are input in the system memory, the processor activates the DMAC module in a software manner. The DMAC module gains control of the system bus by generating a DIRQ signal. The DMAC module copies a value from a system memory address to a local memory of the DMAC module, and moves data to the local memory of the audio accelerating apparatus.

In this case, audio signals are processed in frame units. Accordingly, as shown in FIG. 3, only after the processor reads out all data written in addresses A to A+(N−2), the DMAC module starts operating.

In addition, only after the transfer of data is completed, the DMAC module generates an interrupt to notify that the transfer of data is completed and the processor activates the audio accelerating apparatus while clearing the interrupt.

Meanwhile, the monitoring unit of the audio signal processing apparatus according to the present invention recognizes the time at which a new value is input from the processor to the system memory and moves the corresponding value from the system memory to the local memory.

As shown in the upper part of FIG. 4, the writing of data to the local memory is performed in almost real time, and the time required for moving data stored in the system memory to the local memory is reduced as compared when moving data under the control of the DMAC module. In addition, the data access operation of the processor mainly occurs in a cache. That is, the audio signal processing apparatus controls the system bus itself, thereby preventing operational load from being increased on the system.

As shown in FIG. 4, the present invention has reduced operating time by the time corresponding to the activation of the DMAC module in a software manner, the gaining of the control of the system bus after DIRQ, the data transfer time of twice the amount of data and the interrupt processing.

FIG. 5 is a timing diagram illustrating a case where shared data processed by the audio signal processing apparatus is moved to the system bus.

The upper part of FIG. 5 is a timing diagram illustrating a case where data is moved in the audio signal processing system proposed according to the present invention. The lower part of FIG. 5 is a timing diagram illustrating a case where data is moved by use of the DMAC module in a conventional system.

As shown in FIG. 5, the conventional module operates as follows. Signal processing values are stored in a local memory and the DMAC module is active to a DREQ signal. After the control of the system bus is gained, data is moved from the local memory of the audio signal processing apparatus a local memory of the DMAC module. Then, the corresponding data is moved from the local memory of the DMAC to the system memory. After the transfer of data is completed, the DMAC module generates an interrupt to activate an interrupt processing module of the processor, and the processor recognizes completion of an operation of the audio signal processing apparatus.

Meanwhile, according to the present invention, the resultant values of signal processing are stored in the local memory at predetermined time intervals. Due to the inherent characteristics of codec signal processing, even if data processing is achieved in a hardware manner, data output is achieved at predetermined time intervals. A memory device compares the data value newly stored in the local memory with a data value previously stored in the local memory. If the new data value is different from the value previously stored in the local memory, the memory device transfers the corresponding value to the system memory through an I/F control device. If the new data value is not different from the value previously stored in the local memory, the memory device does not perform additional operations. As shown in FIG. 4, the present invention reduces the operating time by the time corresponding to the activation of the DMAC module in a software manner, the gaining of the control of the system bus after DIRQ, the data transfer time of twice the amount of data and the interrupt processing.

The disclosure can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves such as data transmission through the Internet. The computer readable recording medium can also be distributed over a network coupled computer systems so that the computer readable code is stored and executed in a distributed fashion

Also, functional programs, codes, and code segments for accomplishing the present invention can be easily construed by programmers skilled in the art to which the present invention pertains. A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An audio signal processing method achieved in a signal processing module which is physically separate from a control module for controlling overall operations of an audio signal processing apparatus, the method comprising:
recognizing input of new data to a system memory;
reading the new data from the system memory, upon the recognition of the input of the new data; and
writing the new data read from the system memory to a local memory.

2. The audio signal processing method of claim 1, further comprising storing a processing result of the data written in the local memory in the local memory.

3. The audio signal processing method of claim 2, further comprising transferring the processing result the data that is stored in the local memory to the system memory.

4. The audio signal processing method of claim 3, wherein, if the processing result of the data that is stored in the local memory is different from a data value that is previously stored in the local memory, the processing result is transferred to the system memory.

5. The audio signal processing method of claim 1, further comprising copying the data, which is stored in the system memory, to the local memory in a system initialization.

6. The audio signal processing method of claim 1, wherein the recognizing of the input of the new data is performed by monitoring an address value of a system bus.

7. An audio signal processing apparatus, the apparatus comprising:
a monitoring unit configured to monitor whether new data is input to a system memory;
a local memory which is a storage space physically separate from the system memory and configured to store data; and
a local memory control unit configured to read the new data from the system memory if the input of the new data is recognized in the monitoring unit, store the new data read from the system memory in the local memory and transfer a processing result of the data stored in the local memory to the system memory.

8. The audio signal processing apparatus of claim 7, further comprising a signal processing unit configured to perform preset signal processing on the data stored in the local memory and store a processing result value in the local memory.

9. The audio signal processing apparatus of claim 7, wherein, if the processing result value stored in the local memory is different from a data value that is previously stored in the local memory, the local memory control unit transfers the processing result value to the system memory.

10. The audio signal processing apparatus of claim 7, wherein the monitoring unit is configured to monitor an address value of a system bus.

11. A communication terminal apparatus comprising an audio signal processing apparatus, the audio signal processing apparatus comprising:
a monitoring unit configured to monitor whether new data is input to a system memory;
a local memory which is a storage space physically separate from the system memory and configured to store data; and
a local memory control unit configured to read the new data from the system memory if the input of the new data is recognized in the monitoring unit, store the new data read from the system memory in the local memory and transfer a processing result of the data stored in the local memory to the system memory.

12. The communication terminal apparatus of claim 11, further comprising a system memory control unit configured to copy the data stored in the system memory to the local memory in a system initialization.
